(19) United States
(12) Patent Application Publication
(10) Pub. No.: US 2008/0167920 A1
(43) Pub. Date: Jul. 10, 2008

(54) METHODS AND APPARATUS FOR DEVELOPING CYBER DEFENSE PROCESSES AND A CADRE OF EXPERTISE

(76) Inventors: Robert Schmidt, Chicago, IL (US); Gregory J. Rattray, San Antonio, TX (US); Christopher J. Fogle, San Antonio, TX (US)

Correspondence Address: BELL, BOYD & LLOYD, LLP, P.O. Box 1135, CHICAGO, IL, 60690, US

(21) Appl. No.: 11/947,655

(22) Filed: Nov. 29, 2007

Related U.S. Application Data
(60) Provisional application No. 60/867,692, filed on Nov. 29, 2006.

(51) Int. Cl. G06Q 10/00

(52) U.S. Cl. 705/7

(57) ABSTRACT

Methods and apparatus for developing cyber defense processes and a cadre of expertise are disclosed. The methods and apparatus improve the ability of an enterprise to defend against cyber attacks by (i) identifying risks and critical operations; (ii) determining the associated situational awareness and identifying threats by adversaries; (iii) organizing for defense from cyber attack; (iv) assessing the ability of the enterprise to respond; (v) improving the enterprise by learning from the assessment; and (vi) delivering improved cyber defense processes and cadre of expertise.

### PRIORITY CLAIM

This application claims priority to and the benefit of U.S. Provisional Patent Application Ser. No. 60/867,692 filed on Nov. 29, 2006, the entire contents of which is hereby incorporated.

### TECHNICAL FIELD

The present disclosure relates in general to cyber defense, and, in particular, to methods and apparatus for developing cyber defense processes and a cadre of expertise.

### BACKGROUND

Administrators of complex business processes typically take precautions to help ensure that their business processes continue to operate despite the occurrences of certain unwanted events. For example, many business processes use computer systems for at least a portion of the business process. Often, precautions are taken to ensure that data continues to flow in to and out of these computer systems despite failures of certain devices in the system. For example, backup storage systems and redundant communications paths are often used to increase the integrality of a computing system.

Most treatments of the risks due to cyber threats tend toward one of two poles: widespread disruption to Internet users which has been observed in nearly every corner of the globe, and the largely undemonstrated catastrophic attack on a nation's critical infrastructure. While these are not mutually exclusive phenomena, they tend to overlook the more realistic—and perhaps more devastating—risks from long-term campaigns targeting large enterprises and their critical operations and information assets. The potential cascading effects of attacks against a large enterprise can have far-reaching effects on a national or global scale. Large enterprises—for the purposes of this framework—include such entities as public utilities; financial services companies; transportation and logistics providers; local, state, and national governments; and global energy companies. Due the nature of their usually complex information requirements and dispersed operating environments, they can be more difficult to defend. And unlike casual Internet home users or smaller enterprises, “technology-only” solutions are often difficult to tailor effectively in order to adequately cover the enterprise. Compounding the risk is their generally heavy investment and reliance on information infrastructures for their critical operations and services.

Because of this complex risk picture, large enterprises must balance their typical investments in security technology solutions with a focus on developing and maintaining human capital necessary to mount an effective defense and maintain their critical business operations.

### BRIEF DESCRIPTION OF THE DRAWINGS

FIG. 1 is a high level block diagram of an example business system showing direct and indirect relationships between business entities.

FIG. 2 is a high level block diagram of an example communications system.

FIG. 3 is a more detailed block diagram showing one example of a computing device.

FIG. 4 is a flowchart of an example process to develop cyber defense processes and a cadre of expertise.

FIG. 5 is a cycle diagram illustrating an example of evolving cyber threats and the adaptation of defenses.

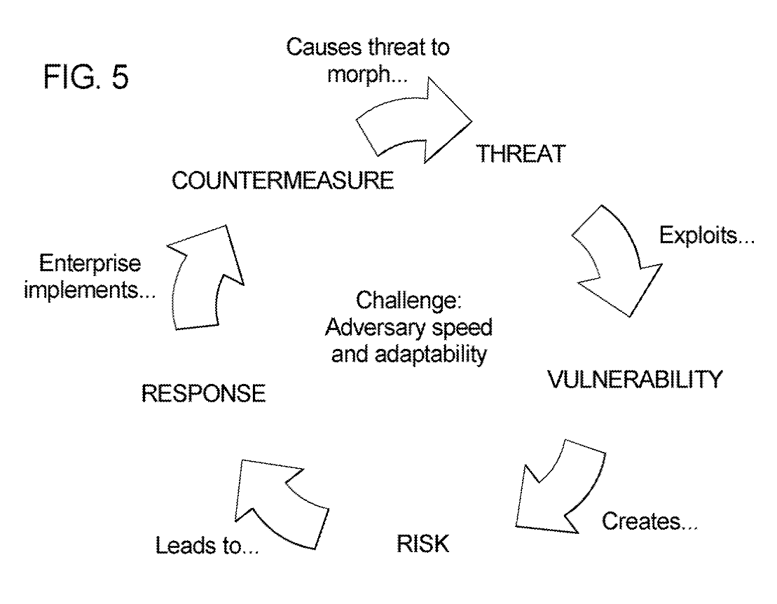

FIG. 6 is a block diagram of an example enterprise cyber defense system.

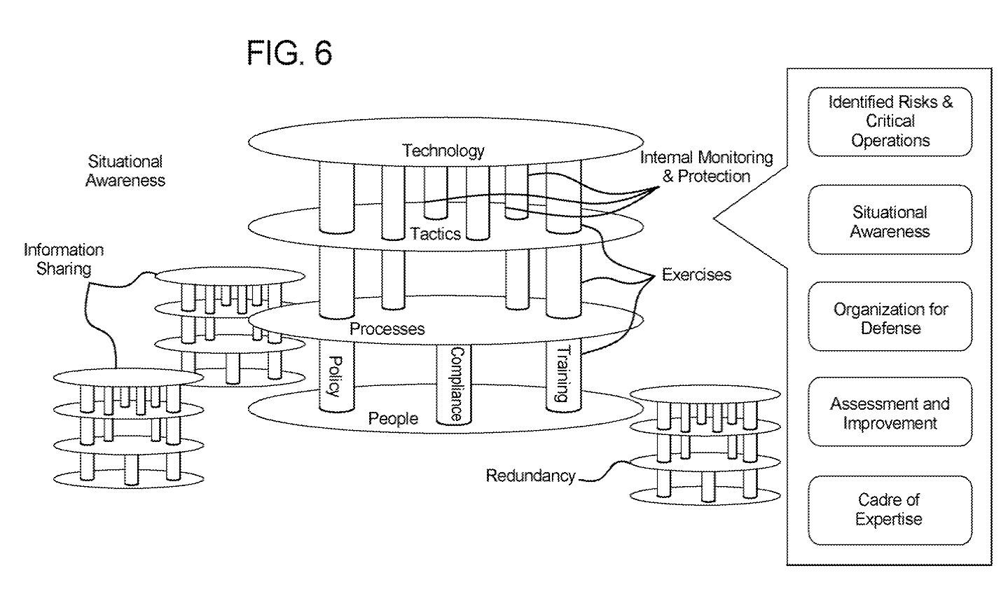

FIG. 7 is a block diagram of an example threat awareness process.

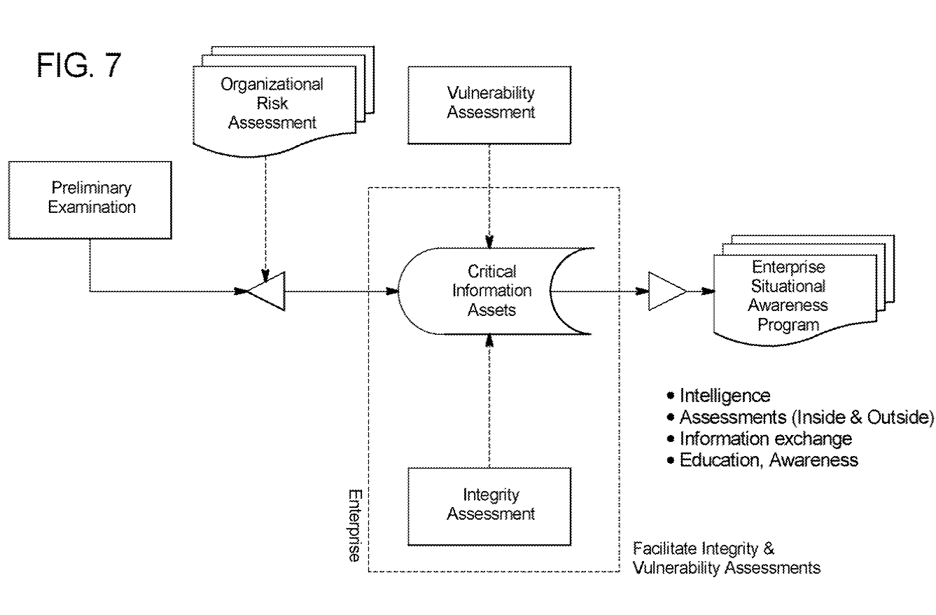

FIG. 8 is a block diagram of an example enterprise tactician process.

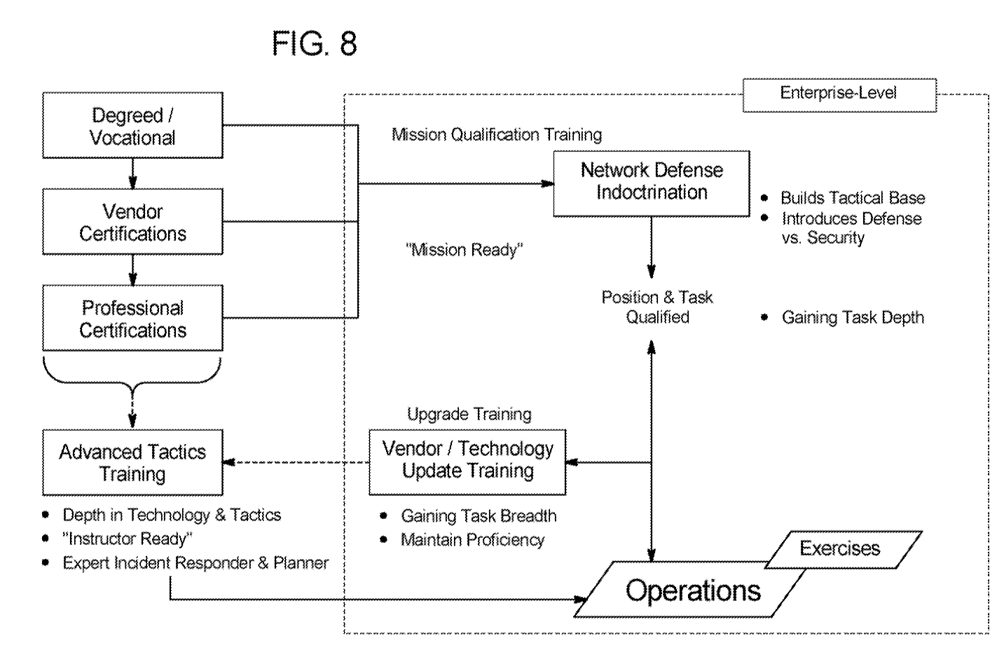

FIG. 9 is a block diagram of an example cyber defense exercise.

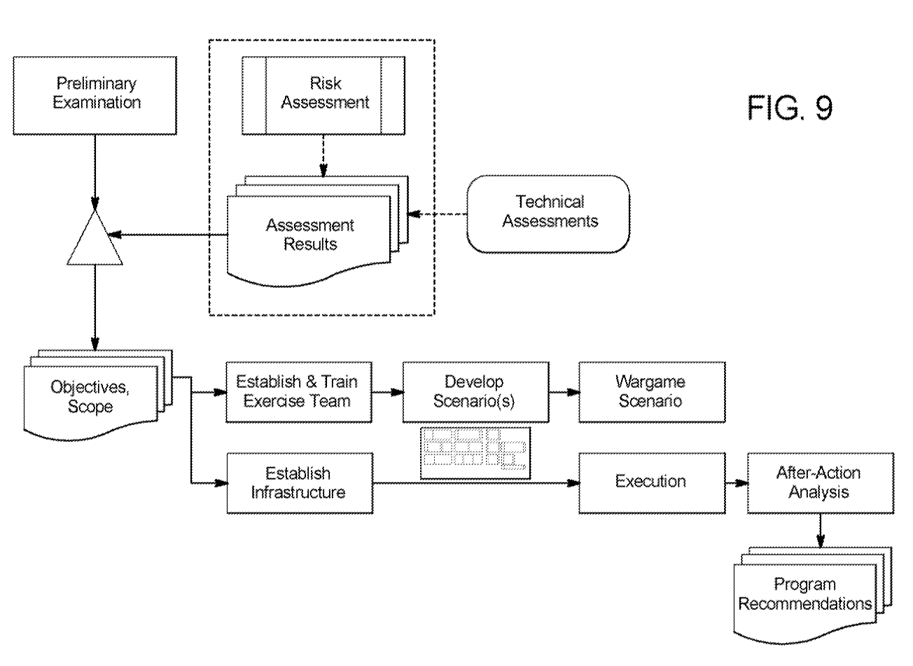

FIG. 10 is a block diagram of an example process for applying enterprise cyber defense principles.

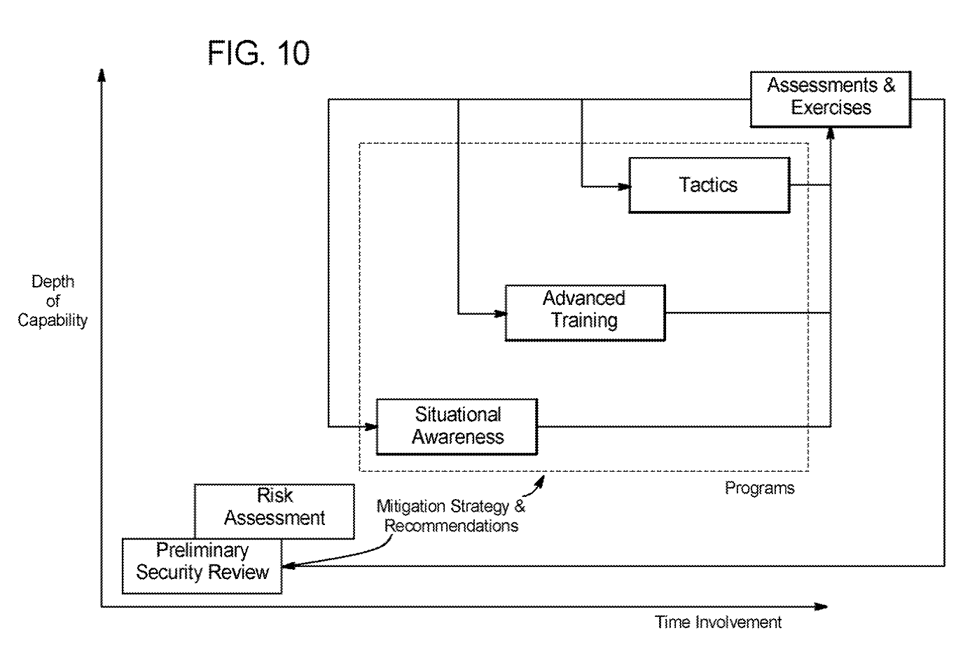

FIG. 11 is a block diagram of an example holistic view of the application of an enterprise cyber defense system.

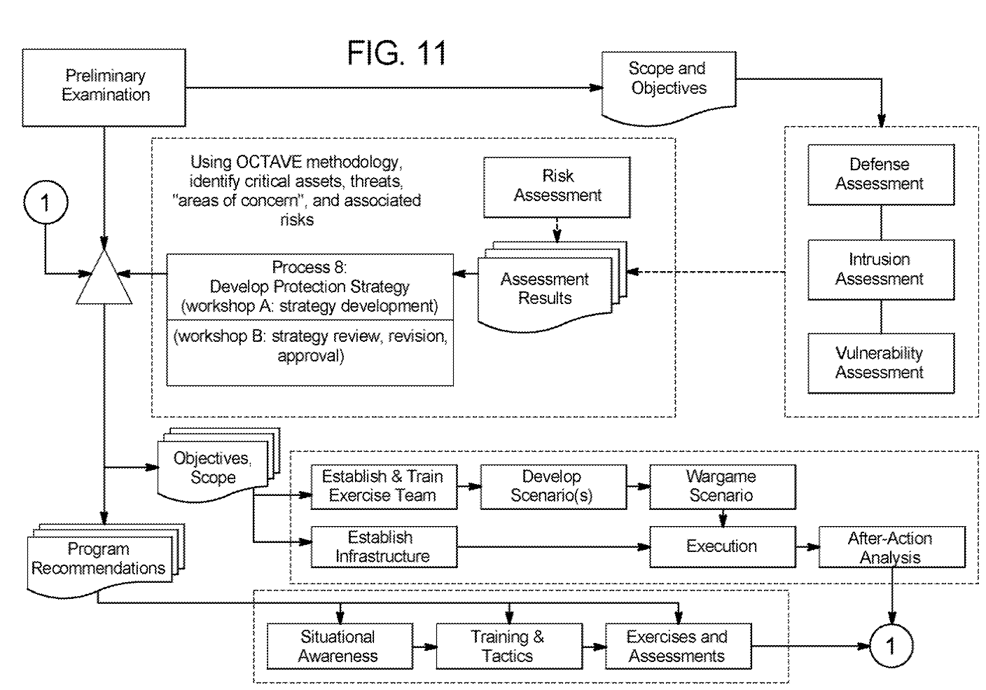

### DETAILED DESCRIPTION OF EXEMPLARY EMBODIMENTS

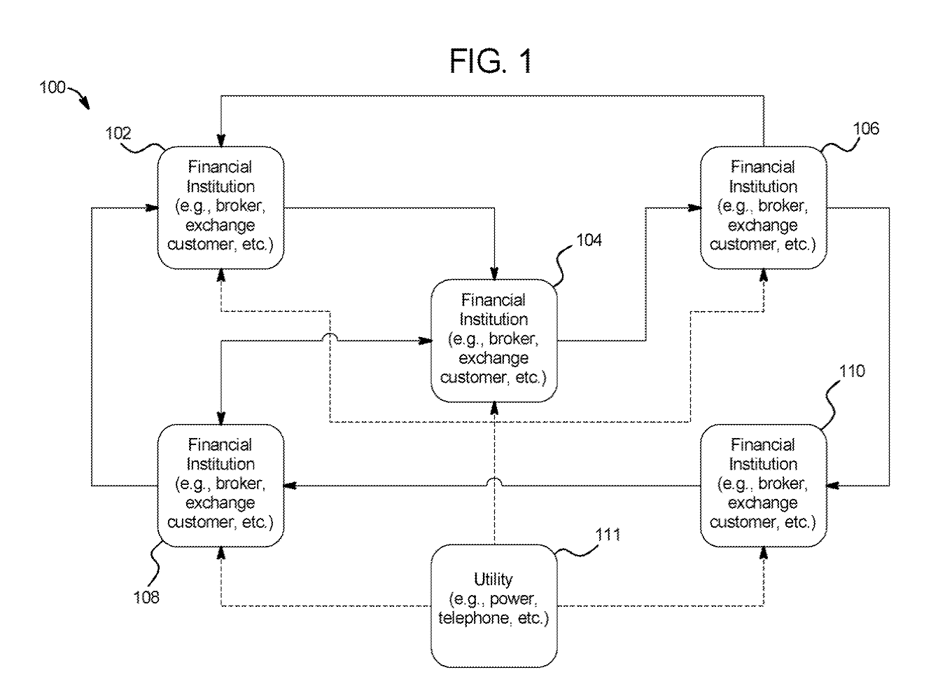

FIG. 1 is a high level block diagram of a business system 100 showing direct and indirect relationships between business entities 102-111. Example business entities include clearing member firms, clearing corporations, exchange brokers, settlement corporations, settlement and depository banks, price reporting corporations, service bureaus, power companies, and telephone companies. In the example illustrated in FIG. 1, five financial institutions 102-110 are shown. However, any number of financial institutions may be simulated by the disclosed system. In addition to the financial institutions 102-110, other business entities may be included in the simulation. For example, one or more utility companies such as a power company, a telephone company, etc. may be included in the simulation.

Each business entity may have one or more direct and one or more indirect relationships. For example, financial institution 104 has a direct relationship with financial institution 102, financial institution 106, and financial institution 108. Specifically, financial institution 104 takes inputs directly from financial institution 102 and financial institution 108. In addition, financial institution 104 feeds outputs directly to financial institution 106 and financial institution 108. These relationships may be based on any user defined criteria. For example, relationships between business entities may be at a business model level and/or a data connectivity level. Some business entities may have direct relationships with a large number of the other business entities. For example, a power company may have a direct relationship with all of the business entities in a particular geographic region.

Financial institution 104 may have an indirect relationship with financial institution 106, financial institution 108, and/or financial institution 110. Specifically, financial institution 106 may indirectly affect financial institution 104 via financial institution 102. In addition, financial institution 106 may affect financial institution 110, which in turn may affect financial institution 108, which in turn may affect financial institution 104. Financial institution 108 may have a direct affect on financial institution 104 and an indirect affect on financial institution 104 via financial institution 102. In fact, financial institution 104 may affect financial institution 108, which in turn may affect financial institution 102, which in turn may loop all the way back to affect financial institution 104. In this example, financial institution 104 does not have an indirect relationship with financial institution 102, because financial institution 102 does not send outputs to any financial institutions other than financial institution 104.

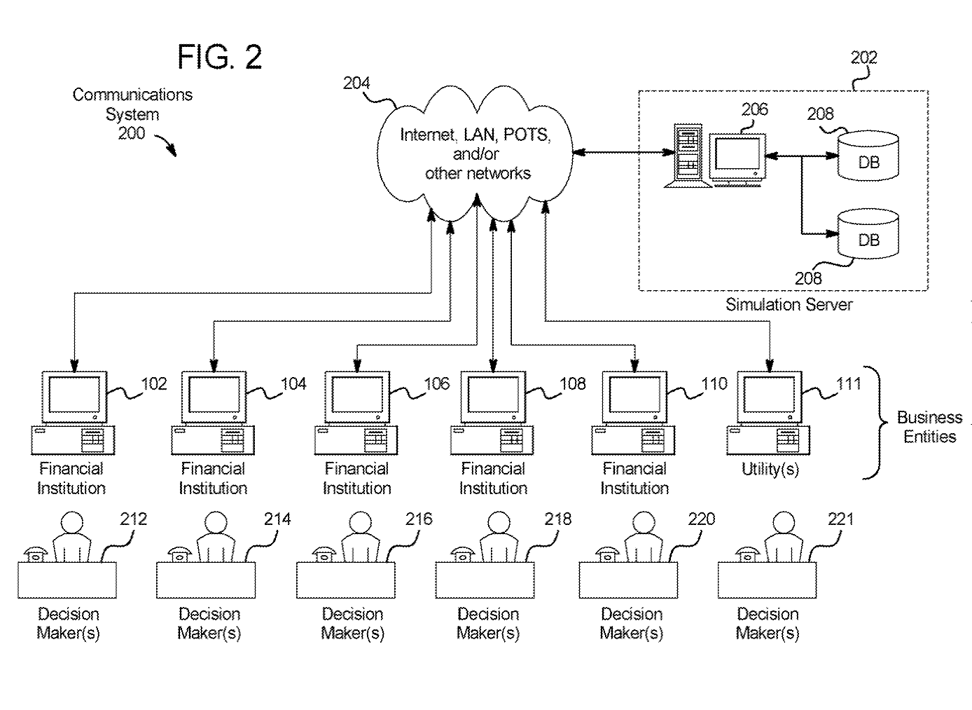

In order to simulate the effect of a disruption somewhere in the business system 100 including any ripple effects caused by both the direct and the indirect relationships, a network communications system is preferably used. A high level block diagram of an example network communications system 200 is illustrated in FIG. 2. The illustrated system 200 includes one or more client devices associated with the business entities 102-111 and one or more simulation servers 202. Each of these devices may communicate with each other via a connection to one or more communications channels 204 such as the Internet and/or some other data network, including, but not limited to, any suitable wide area network or local area network. It will be appreciated that any of the devices described herein may be directly connected to each other instead of over a network.

The simulation server 202 may include one or more computing devices 206 and one or more databases 208. One simulation server 202 may interact with a large number of other devices. Accordingly, each simulation server 202 is typically a high end computer with a large storage capacity, one or more fast microprocessors, and one or more high speed network connections. Conversely, relative to a typical server 202, each client device associated with the business entities 102-111 typically includes less storage capacity, a single microprocessor, and a single network connection. During a simulation, each participating client device is associated with one or more decision makers 212-221.

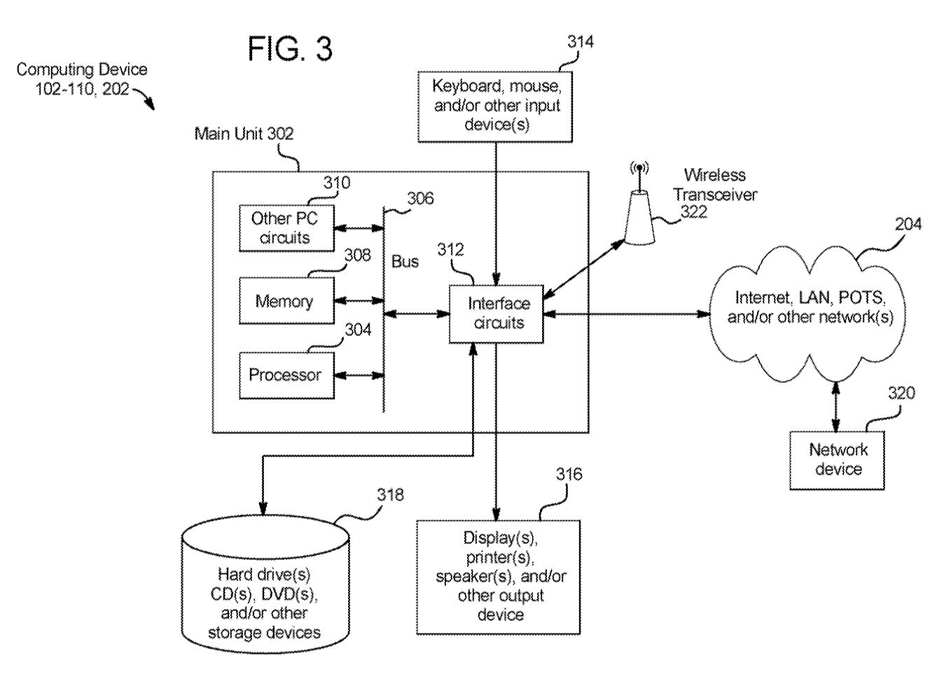

A more detailed block diagram of the electrical systems of an example computing device (e.g., a client 102-111 or a server 202) is illustrated in FIG. 3. Although the electrical systems of these computing devices 102-111, 202 may be similar, the structural differences between these devices are well known. The example computing device 102-111, 202 includes a main unit 302 which preferably includes one or more processors 304 electrically coupled by an address/data bus 306 to one or more memory devices 308, other computer circuitry 310, and one or more interface circuits 312. The processor 304 may be any suitable processor, such as a microprocessor from the INTEL PENTIUM® family of microprocessors. The memory 308 preferably includes volatile memory and non-volatile memory. Preferably, the memory 308 stores a software program that interacts with the other devices in the communications system 200 as described below. This program may be executed by the processor 304 in any suitable manner. The memory 308 may also store digital data indicative of documents, files, programs, web pages, etc. retrieved from another computing device 102-111, 202 and/or loaded via an input device 314.

The interface circuit 312 may be implemented using any suitable interface standard, such as an Ethernet interface and/or a Universal Serial Bus (USB) interface. One or more input devices 314 may be connected to the interface circuit 312 for entering data and commands into the main unit 302. For example, the input device 314 may be a keyboard, mouse, touch screen, track pad, track ball, isopoint, and/or a voice recognition system.

One or more displays, printers, speakers, and/or other output devices 316 may also be connected to the main unit 302 via the interface circuit 312. The display 316 may be a cathode ray tube (CRTs), liquid crystal displays (LCDs), or any other type of display. The display 316 generates visual displays of data generated during operation of the computing device 102-111, 202. The visual displays may include prompts for human input, run time statistics, calculated values, data, etc.

One or more storage devices 318 may also be connected to the main unit 302 via the interface circuit 312. For example, a hard drive, CD drive, DVD drive, and/or other storage devices may be connected to the main unit 302. The storage devices 318 may store any type of suitable data.

The computing device 102-111, 202 may also exchange data with other network devices 320 via a connection to the network 204. The network connection may be any type of network connection, such as an Ethernet connection, digital subscriber line (DSL), telephone line, coaxial cable, etc. Users of the communications system 100 may be required to register with one or more of the computing devices 102-111, 202. In such an instance, each user may choose a user identifier (e.g., e-mail address) and a password which may be required for the activation of services. The user identifier and password may be passed across the network 204 using encryption. Alternatively, the user identifier and/or password may be assigned by the computing device 102-111, 202.

Security and defense are not mutually exclusive activities. One includes the other—and which one is more encompassing varies by proponent. For the purposes of this framework, security is considered generally passive, preemptive measures taken to define a static state of protection for network elements and the information (data) that traverses it. Defense, on the other hand, encompasses measures and activities which constitute actively engaging a threat environment. Engagement occurs during the necessary monitoring and strengthening of the defensive capacity of an enterprise prior to an attack; as well as, the response phase during and after an attack. Put another way, security focuses on protecting a network and its resources; defense focuses on maintaining the continuity of critical operations and availability of key information assets in the face of an attack.

Large enterprises—for the purposes of this framework—are entities that have a significant reliance on an information technology (IT) infrastructure for their core business operations, and they have a corresponding significant investment in that infrastructure. They include public utilities; financial companies; transportation and logistics providers; local, state, and national governments; and global energy companies. They share the following characteristics, in varying degrees:
Dispersed or distributed operations. The diversity of their operations includes geographical and/or functional distribution. The IT infrastructure supporting the distributed operations is usually a combination of owned and leased. Responsibility for security and operations of the infrastructure is correspondingly distributed (shared).
Critical assets or operations that warrant protection. Large enterprises have significant assets of operations that warrant protection beyond what the industry generally considers “ordinary measures.” The value of those assets may be assessed in dollars (financial networks and data), intellectual value (“intellectual property”), public necessity (utilities and critical infrastructure), and state/national security. Disruption of these critical assets or operations will generally yield cascading negative effects across a wide geopolitical and business landscape.
Full-time, 24×7 operations or the resources to accommodate them. Because of the distributed nature of the operation and the critical need to protect it, large enterprises can provide continuous monitoring and protection services. These may be routine coverage or surge capacity to meet a 24×7 requirement, and it may be a combination of indigenous and contracted capability. This framework proposes certain levels of investment in human capital that a smaller enterprise may find difficult to justify. Implementation of this framework within an enterprise also may not be optimal for an otherwise large enterprise that outsources critical protection functions, such as network monitoring, forensics and analysis, and incident response.

Some characteristics, not limited to large enterprises, are common to entities with a large user population and functional organization including:
Combined operations and security responsibilities. In this context, “operations” refers to the health and functioning of the IT infrastructure (network). Security refers to the protection measures associated with ensuring infrastructure and data availability, integrity, and authentication. Many organizations today levy the responsibility for security on the same IT staff tasked with ensuring the network operates effectively. Consequently, staffs must make decisions balancing security with ease of use (convenience) when it comes to operations of the network.
Range of user experience and skills. Larger enterprises are likely to have a broad range of familiarity and skill among its user population. This translates into potential trade-offs—sometimes significant ones—when it comes to implementing security policies and training programs. Also, depending on the enterprise, users include a mix of internal users and external customers (clients)—additionally compounding the skill/experience variables, and possibly introducing attack vectors that favor sophisticated threats.
Varying levels of interest and involvement by leadership and management. In the context of network security/defense, this describes how network-savy and involved the leadership is in decision making. It also refers to the level at which they are involved—ranging from strategic decisions-only, to developing the necessary policies and personally directing response actions. These factors dictate the required levels of autonomy—and associated levels of trust—that an enterprise comfortably places upon its IT staff.

The cyber threat environment that today's large enterprises typically must navigate has changed rapidly over time. There are at least three stages in threat evolution including: (i) dedicated hobbyists wielding a finite set of tools to exploit limited systems with relatively benign effects; (ii) legions of unsophisticated script-kiddies utilizing easy-to-use tools (which they don't often understand) to produce intense localized disruption; and (iii) bands of loosely connected, hard-core hackers whose malware and sophisticated exploits have wreaked havoc on a global scale.

The prevailing motivations in each phase have generally been enjoyment, curiosity, and pride. Running through each phase has been the constant threat that someone with access to the internal network—either witting or unwitting—can hold an enterprise hostage and create discord that is equal parts damaging and difficult to trace.

The next phase in threat evolution is a more advanced, persistent threat. It is characterized by greater sophistication and skill, rapid collaboration, and increasingly structured relationships to overwhelm complex network security mechanisms—oftentimes from the inside. Their motivation is becoming increasingly profit-focused, and their modus operandi includes persistence and stealth. It includes possible state-sponsored actors whose effects contribute to long-term influence and exploitation campaigns, as well as devastating effects to facilitate military action. Their signatures include the use of zero-day exploits, distributed agent networks, advanced social engineering techniques such as spear phishing, and long-term data mining and exfiltration. Their flexibility and robust kitbag of tools and techniques makes the advanced threats particularly difficult to successfully defeat with today's technology-heavy network security focus.

The standard risk equation is well-known: risk results from the presence of a vulnerability coupled with the existence of a threat actor motivated and skilled enough to exploit that threat.

In anticipation of the threat—or as often the case, in response to an attack—an enterprise implements countermeasures designed to negate the threat or mitigate the effects of the attack. Over time, the threat morphs, additional vulnerabilities emerge, or exploits are developed to take advantage of unaddressed vulnerabilities. The result is a cycle of activity that favors the side that is more rapidly adaptable. Because large enterprises have so many “moving pieces” and complex operational requirements, they often find themselves on the losing end.

In an effort to improve their responsiveness, they invest heavily in the latest technology to automate detection and response. Such a strategy is less effective as the complexity of the environment increases, and it doesn't provide a measure of their ability to respond—especially with respect to their ability to detect and defeat emerging advanced persistent threats.

An enterprise chooses to address risk based on the likelihood it will occur and the resulting impact to their critical operations if it does. They typically spend a good deal of time and money addressing the most likely threats, even if the impact of those threats on their enterprise is minimal. Applying automated technology solutions to these problems can yield dramatic increases in detection and decreases in threat activity, which looks impressive and contributes to due care; however, it leaves the organization in a false sense of security.

Addressing the advanced persistent threat can be a tougher problem and one that doesn't seem to readily get leadership attention. In terms of safeguarding what is truly critical in an organization, the advanced persistent threat represents the greater risk. Unlike more ubiquitous threats, technology solutions are less effective. What is needed is flexibility and equally advanced defensive prowess in order to mitigate these more serious threats. In order to obtain this level of readiness and response capability, an enterprise must obtain a keen awareness of the health of its information assets, and invest in human capital by establishing training, tactics, and exercise programs. The latter programs serve to train enterprise defenders, as well as validate an enterprise's overall defense posture.

Retooling an enterprise to incorporate the practices disclosed herein requires an organization to institutionalize network defense “best practices” using documented processes maintained by a cadre of tactics experts. An organization that implements these defense practices is interested in knowing how they'll respond to actual attacks. It understands that a flexible and skilled defense force can overcome some technology shortfalls and zero-day attack vectors, and that such a force requires increased situational awareness of the threats and the true status of the assets they are defending.

The present approach to this problem is to establish a holistic awareness of the threat, root out the best practices on dealing with it, exercise and continually assess the effectiveness of the tactics, and then institutionalize those tactics for future generations of defenders. In order to adequately defend resilient networks, trained operators are infused with better situational awareness and supported by training and tactics programs.

Organizations that implement a the system described herein extend exisintg activities, as well as adding additional functionality and programs. Such an enterprise seeks to improve their capacity to respond to an attack and ensure the availability of critical assets or business operations. The following characteristics are associated with these defenses:
Balanced Investments in People, Processes, and Technology. Organizations seek to increase their underlying investments in recruiting, developing, and supporting a skilled security staff. They don't arbitrarily cut investments in technology, but rather they see their investments in people as a way to ensure the technology is used effectively and to mitigate capability gaps associated with the technology.
Response-oriented Measures of Effectiveness. Organizations assess their security posture based upon their readiness to respond and the demonstrated effectiveness of that response. It extends—or validates—compliance to standards with a demonstrated ability to ensure critical business operations are maintained in the face of realistic threats.
Advanced Security Education and Training. Organizations seek to develop a cadre of highly skilled cyber security and defense professionals. They extend basic user training with more advanced topics. They utilize various private, commercial, and government sources for training. Training includes recurring threat awareness information and formal post-event analysis of current network incidents.
Information Sharing. Organizations take advantage of business or sector-specific forums for exchanging information with other security professionals. Partnerships between industry and government exist to increase the effectiveness and speed at which vulnerability and defense information is shared.
Situational Awareness. Organizations undertake activities to determine threats and potential vulnerabilities resident in their information infrastructure, emerging threats to their network and business (sector), and near-real time analysis of network attacks. Traditional network intrusion systems are monitored on a 24/7 basis with an active response capability at the ready.
Operational Security and Defense. During incident response, primary importance is assigned to ensuring the enterprise's critical business or assets remain accessible and effective. This may call for allowing an attack against a less-critical asset to proceed as personnel increase monitoring and protection of more critical infrastructure.
Institutionalized Processes and Best Practices. Organizations recognize the need to document procedures and practices to ensure continuity as people exit or move within an enterprise. Capturing tactics for employing the tools at their disposal is an essential activity.
Routine and Periodic Assessments & Exercises. Organizations have a formal program to regularly assess their capacity to defend and the effectiveness of their tactics, policies, and procedures. Exercises also afford training opportunities for the enterprise.

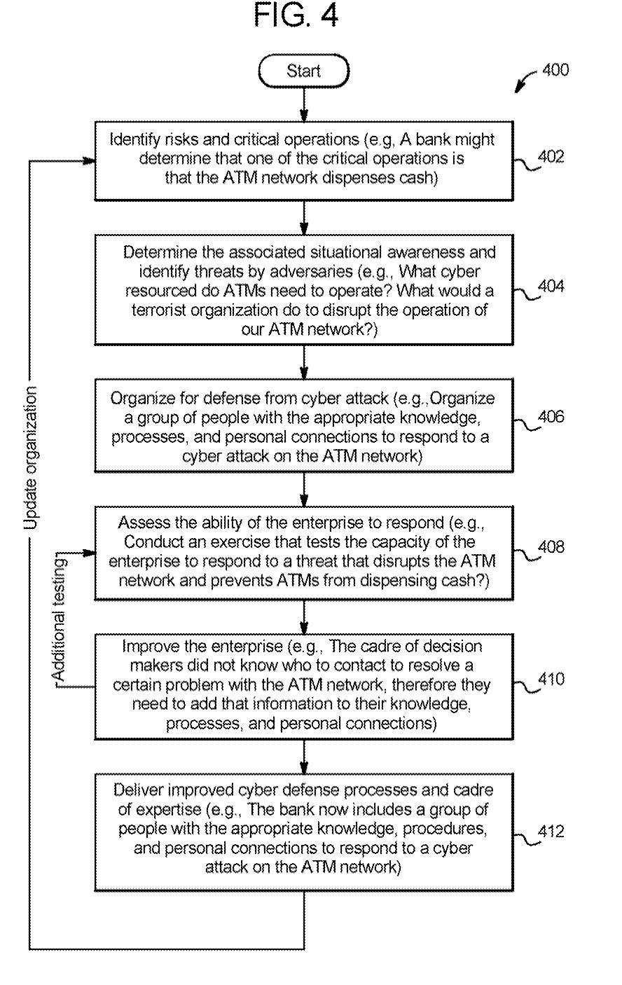

A flowchart of an example process 400 to develop cyber defense processes and a cadre of expertise is illustrated in FIG. 4. Preferably, the process 400 is embodied in one or more software programs which is stored in one or more memories and executed by one or more processors. Although the process 400 is described with reference to the flowchart illustrated in FIG. 4, it will be appreciated that many other methods of performing the acts associated with process 400 may be used. For example, the order of many of the steps may be changed, and some of the steps described may be optional.

A balanced approach to strengthening defensive capacity can yield greater flexibility, which in turn makes the enterprise better equipped to handle emerging advanced cyber threats. It is compatible with other aspects of business continuity and risk management principles, and it easily integrates with broader enterprise security planning. Enterprise Cyber Defense is includes at least five principles: (i) Identify Risks and Critical Operations; (ii) Establish Situation Awareness; (iii) Organize for Defense; (iv) Assess and Improve Enterprise Defenses; and (v) Establish a Cadre of Expertise (through balanced investments in people, technology, and processes).

This framework includes an interdependent application of these principles. Identifying key information assets associated with critical enterprise operations allows the enterprise to focus training programs and information sharing. An enterprise's organizational structure and functional model is put to the test in exercises and drills, which also allow the organization to discover operational or procedural vulnerabilities and gaps, validate existing or proposed response actions, and establish internal benchmarks and baseline security practices.

The process 400 begins by identifying risks and critical operations (block 402). For example, A bank might determine that one of the critical operations is that the ATM network dispenses cash. The goal of this activity is to ensure the enterprise adopts a holistic view of their operations and associated critical information assets. An enterprise must know what operations are vital to their overall business goals, what information assets are associated with the critical operations, know the associated vulnerabilities of and threats to these assets, and then map these assets to the risk to the enterprise. Once this is understood, an enterprise can develop the necessary security strategy, tactics, and mitigation measures to ensure their critical operations continue in the face of the ever-changing threat environment.

A myriad of risk assessment techniques and models may be used for this step. The salient point is that the analysis and assessment are conducted by a cross-functional team—representatives from the business lines, as well as the IT and security staffs. (One example of a holistic approach is the Operationally Critical Threat, Asset, and Vulnerability Evaluation^{SM} (OCTAVE^{SM}) Method from the Carnegie Mellon University-Software Engineering Institute (CMU-SEI).)

Next, the process 400 determines the associated situational awareness and identify threats by adversaries (block 404). For example, What cyber resources do ATMs need to operate? What would a terrorist organization do to disrupt the operation of our ATM network? Before an enterprise can develop its defensive responses and countermeasures, it must invest in its ability to maintain awareness of emerging threats. This step requires focus in two critical areas: sharing information with other enterprises and the overall cyber security/defense community, and actively monitoring its own network (defenses)—both internally and externally.

Enterprises should consider dedicating resources to the collection of intelligence (i.e. threat information) and the task of examining their data and information systems for signs of past and current intrusions. The presence of or artifacts of malicious activity within an enterprise's systems and data resources—along with traffic patterns and anomalies—must be actively sought and considered in the context of stealthy, persistent, advanced threats.

Next, the process 400 organizes for defense from cyber attack (block 406). For example, a group of people may be assembled with the appropriate knowledge, processes, and personal connections to respond to a cyber attack on the ATM network. In the context of Enterprise Cyber Defense, an enterprise seeks a balance among investments in technology, processes, and training (their people) in order to establish a robust capability to defend their operations and critical information assets. Again, the focus of network defense is on keeping critical business operations available and functional. Stopping the attack or protecting the system under attack may not be the primary goal. An enterprise should examine how it's organized internally for defense.

The key to organizing for defense is to establish relationships and functional associations within an enterprise that enable information sharing, clearly identified command and control, and the ability to respond quickly—and at times, preemptively—to mitigate risks to critical information assets and business operations. Elements dedicated to cyber defense should be part of an overarching, integrated response capability for the enterprise. Traditional business continuity and disaster planning activities should include cyber dimensions as part of regular drills and exercises.

Part of this approach—which is similar to how the U.S. military develops its forces—is to create relationships and command and control (C2) in order to rapidly detect and effectively respond to threats. Functions are defined within an organization for threat analysis, network monitoring, intrusion detection, incident response, and system recovery. Key positions are identified within this structure as its tactics and standardization/evaluation cadre. This cadre is responsible for training and proficiency evaluations, as well as continuous improvement of the enterprise defenses. In addition, it documents response actions to a myriad of potential events—from “low and slow” data theft to massive denial of service events. These actions encompass management and policy decisions, continuity of operations or business continuity planning, and activation of network protection measures. This baseline set of response options then becomes the foundation for integrated training, tactics, and exercise programs.

Next, the process 400 assess the ability o he enterprise to repond to a cyber attack (block 408). For example, an exercise may be conducted that tests the capacity of the enterprise to respond to a threat that disrupts the ATM network and prevents ATMs from dispensing cash? An enterprise must go beyond traditional vulnerability assessments. The best way to assess how effectively an enterprise can respond to a threat is to observe in the face of a real or simulated threat. In order to do this effectively, the enterprise should include three aspects to their assessment program:

Vulnerability Assessment—Traditional red team & penetration testing to determine vulnerabilities of systems in an enterprise network. Scope to a subset of systems or network services associated with their critical business operations, or other areas of concern identified by the executive sponsor. Identify off-limit systems and data by such controls as restricted IP ranges, sensitive data, or risk mitigation procedures. Determine ROE for immediate action required in the event a critical vulnerability or risk is discovered. Determine access methods and requirements to facilitate the assessment from internal and/or external networks, as appropriate.

Intrusion/Integrity Assessment—Internal assessment looking for indications or evidence of current and past intrusions, resident malware (viruses, trojans, worms, agents, services), and vulnerable data. Scope to a subset of systems or data associated with their critical business operations, or other areas of concern identified by the executive sponsor. Identify off-limit systems and data by such controls as restricted databases, sensitive data, or risk mitigation procedures. Determine ROE for immediate action required in the event a critical vulnerability or risk is discovered.

Defense Assessment—Limited exercises or drills to assess a client's procedures, skills, and ability to respond to attacks or intrusions. Objectives for the defense assessment will be primarily based on threat scenarios developed in coordination with senior leaders and designated trusted agents. Use defense assessments to validate new procedures or processes, deployment of new technologies or tools, or the adequateness of the organization for cyber defense.

Exercises, or drills, are becoming more common in large enterprises, especially in the areas of business continuity and disaster preparedness. Large enterprises must extend these activities to include their responses to cyber threats. Whether solely cyber events or integrated with other business areas, exercises afford large enterprises opportunities to train their people and venues for assessing the efficacy of their tactics and processes. The scope and complexity of the exercise will vary with budget, time, and resource constraints. Three basic types of exercises should be considered by large enterprises: high-level table-top exercises, simulation-driven events, and “live fire” activities. Each can be as limited or encompassing as the organization desires, understanding that a live-fire event that spans all business areas would provided the truest test of an enterprise's response capability.

Next, the process 400 uses what is learned from the assessment stage (block 408) to improve the ability of the enterprise to respond to a cyber attack (block 410). For example, perhaps the cadre of decision makers did not know who to contact to resolve a certain problem with the ATM network, therefore they need to add that information to their knowledge, processes, and personal connections. A large enterprise should constantly strive to improve its defenses in order to effectively engage rapidly changing cyber threats. Key ingredients include maintaining situational awareness of the threat and how it changes, monitoring and analyzing recent activities on the network, and conducting a thorough analysis of real-world and exercise events in order to glean important lessons on how to respond. In addition, an enterprise must have a system in place that encourages outside-the-box thinking and innovation from its employees in the areas of cyber security and defense. Large enterprises must recognize the need to conduct limited scope tests and exercises as a means of assessing the feasibility and effectiveness of recommended improvements before they are adopted as part of the enterprise's kitbag of responses. Finally, the process for improving defenses must be able to respond quickly in order to field an effective defense against rapid changes to the network, threat, and business environments.

Using documented response options and procedures, as well as organizational constructs, the enterprise develops position descriptions for each function and defines the critical tasks and required skill-levels. The training program identifies sources of training, to include internally developed courses, as well as specialized training external to the enterprise. The cyber defense training program extends threat awareness and basic cyber defense training to all employees.

In order to develop a flexible and adaptive defense, enterprise defenders must focus on identifying and documenting tactics—best practices and other employment guidance required to effectively counter threats and employ technology. The label “tactics, techniques, and procedures” generally describes authoritative guidance on how to employ its forces and execute tasks to achieve a desired outcome. (Strategy refers to the positioning of resources—technology and people—prior to engagement; tactics refers to the employment of those resources during the response/engagement phase.) The large enterprise adopts this concept as a means to “professionalize” and strengthen its ability to engage advanced emerging threats to its operations. The enterprise identifies or recruits highly skilled individuals to research, develop, or adopt best practices and lessons learned in the areas of network security and defense. The guidance is documented and incorporated into training opportunities, and it becomes the foundation for the corporate knowledge on protecting the enterprise and responding to threats.

Finally, the process 400 delivers an improved cyber defense processes and cadre of expertise to the enterprise (block 412). For example, the bank now includes a group of people with the appropriate knowledge, procedures, and personal connections to respond to a cyber attack on the ATM network.

Engaging emerging threats with a technology-focused approach potentially yields an extended game of cat-and-mouse between large enterprise network security personnel and threats to the IT infrastructure and critical information assets. In order to achieve asymmetric advantage over a technology-savy threat, large enterprises are encouraged to balance (supplement) their technology investments with a focus on human capital and flexible response capabilities. By focusing on defense, rather than security, and on the human skill set needed to effectively employ their chosen technology, large enterprises are able to grow the necessary capacity to provide a flexible response capability. Such flexibility and skill are needed in order to engage and defeat a rapidly morphing threat. This holistic approach to large enterprise network defense is the key to the Enterprise Cyber Defense process.

In summary, persons of ordinary skill in the art will readily appreciate that methods and apparatus for developing cyber defense processes and a cadre of expertise are disclosed. In order to apply the principles of enterprise cyber defense, an organization should emphasize four (4) activities: (i) Establish the capability to conduct risk assessments; (ii) Gain situational awareness through the use of information sharing forums and internal network vulnerability and integrity assessments; (iii) Establish tactics and advanced training programs to develop the necessary human capital and institutional practices; (iv) Establish tactics and advanced training programs to develop the necessary human capital and institutional practices.

The foregoing description has been presented for the purposes of illustration and description. It is not intended to be exhaustive or to limit the invention to the example embodiments disclosed. Many modifications and variations are possible in light of the above teachings. It is intended that the scope of the invention be limited not by this detailed description of examples, but rather by the claims appended hereto.

What is claimed is:

1. A method of developing cyber defense processes and a cadre of expertise designed to defend an enterprise against evolving cyber threats, the method comprising:
identifying a first critical operation of the enterprise, wherein the first critical operation depends on a plurality of cyber resources;
generating first situational awareness information, the first situational awareness information including (i) information associated with a first cyber threat by a first adversary to the first critical operation of the enterprise and (ii) the plurality of cyber resources;
selecting and educating a plurality of people based on the first critical operation and the first situational awareness information;
generating a first cyber defense process based on the first critical operation and the first situational awareness information;
using a first exercise to access a first ability of the enterprise to respond to the first cyber threat;
supplying at least one of the plurality of people with additional information based on an outcome of the first exercise;
modifying the first cyber defense process based on the outcome of the first exercise;
identifying a second critical operation of the enterprise, wherein the second critical operation depends on the plurality of cyber resources;
generating second situational awareness information, the second situational awareness information including (i) information associated with a second cyber threat by a second adversary to the second critical operation of the enterprise and (ii) the plurality of cyber resources;
selecting and educating the plurality of people based on the second critical operation and the second situational awareness information;
generating a second cyber defense process based on the second critical operation and the second situational awareness information;
using a second exercise to access a second ability of the enterprise to respond to the second cyber threat;
supplying at least one of the plurality of people with additional information based on an outcome of the second exercise; and
modifying the second cyber defense process based on the outcome of the second exercise.

2. The method of claim 1, including delivering the first cyber defense process, the second cyber defense process, and the cadre of expertise to the enterprise.

3. The method of claim 1, wherein the first critical operation of the enterprise includes the second critical operation of the enterprise.

4. The method of claim 1, wherein the first situational awareness information includes the second situational awareness information.

5. The method of claim 1, wherein the first cyber threat includes the second cyber threat.

6. The method of claim 1, wherein the first adversary includes the second adversary.

7. The method of claim 1, wherein the first cyber defense process includes the second cyber defense process.

8. The method of claim 1, wherein the first exercise includes the second exercise.

9. The method of claim 1, wherein the first ability includes the second ability.
